(19) United States
(12) Patent Application Publication
(10) Pub. No.: US 2009/0233515 A1
(43) Pub. Date: Sep. 17, 2009

(54) Plasma Display Panel Manufacturing System

(76) Inventor: Kinya Kisoda, Osaka-shi, Osaka (JP)

Correspondence Address: IP GROUP OF DLA PIPER LLP (US), ONE LIBERTY PLACE, 1650 MARKET ST, SUITE 4900, PHILADELPHIA, PA, 19103, US

(21) Appl. No.: 12/083,125

(22) PCT Filed: Oct. 7, 2005
(86) PCT No.: PCT/JP2005/018626

§ 371 Date: Apr. 4, 2008

(51) Int. Cl. H01J 9/38; H01J 9/46; B25J 19/02; B25J 9/00

(52) U.S. Cl. 445/73; 445/60; 700/259; 700/254; 901/47

(57) ABSTRACT

The system includes a closed loop process line, multiple carts which traverse the process line, a substrate magazine installed to each cart, evacuation tube connectors (each holding an evacuation tube) installed to each cart, an evacuation unit installed to each cart to connect with the evacuation tube connector, a heat treating oven in which a sealing and evacuation process is conducted, a loading-unloading station provided at the process line, substrate and evacuation tube delivery conveyors, control data driven robots provided at the loading-unloading station, a panel discharge conveyor which removes panels from the loading-unloading station, and robot controllers which actuate the robots.

### RELATED APPLICATION

This is a §371 of International Application No. PCT/JP2005/018626, with an international filing date of Oct. 7, 2005 (WO 2007/043159 A1, published Apr. 19, 2007).

### TECHNICAL FIELD

This disclosure relates to a fully automatic system for the manufacture of plasma display panels and the like.

### BACKGROUND

Japanese Unexamined Patent Publication Nos. 2002-175758, 2002-324486, 2003-123648, 2003-141994 and 2003-146409 disclose automation technology applied to components of a plasma display panel manufacturing system.

While automation technology has been partially applied to current plasma display panel manufacturing systems, there is a growing need in the industry for manufacturing facilities which integrate all manufacturing operations into a single continuous automated system. Those operations, as noted here in sequence, deliver assembly parts such as substrates and evacuation tubes, load and arrange the substrates and evacuation tubes on a traverse cart, seal and separate processes for the evacuation tubes after applying a heat treatment and evacuation process in an oven, and unload the finished panels.

In other words, a manufacturing system does not currently exist wherein a continuous automated operation is conducted from the time the substrates are first loaded onto the traversing cart until they come out of the system as a finished display panel. What is in common use today is a batch system in which the substrates are manually loaded into the system. It is well-known that the substrates shift their positions on the cart during the production processes, which makes it difficult to maintain a uniform positional relationship between the substrates and evacuation tubes and to make up a completely automated system providing the advantages of improved yield and reduced energy consumption while removing the limitations to mass production which the current system is faced with.

Thus, it could be advantageous to provide a plasma display panel manufacturing system which provides for fully automated installations of manufacturing plasma display panels and the like.

### SUMMARY

The plasma display panel manufacturing systems comprise:
a closed loop-shaped process line;
multiple carts which traverse the process line in a sequential repetitive start-and-stop movement;
a substrate magazine which is installed to each cart and into which at least one pair of substrates is loaded in a stacked configuration;
an evacuation tube connector which is installed to each cart and to which is attached an evacuation tube facing the pair of substrates;
an evacuation unit which is installed to each cart and connected with the evacuation tube connector wherein operation of the evacuation unit provides an evacuation process through the evacuation tube;
a heat treating oven installed in the process line and which forms connections between the pair substrates and between the evacuation tube and pair of substrates by applying a heat treatment to at least one pair of connected substrates on the cart during traversal therein, and within which an evacuation operation is performed wherein gas residing between the two substrates is evacuated by operation of the evacuation unit through the evacuation tube;
a loading-unloading station set up adjacent to the heat treating oven along the traversing direction of the cart;
a delivery system installed at the loading-unloading station which delivers stacked pair substrates and the evacuation tube;
a robot installed at the loading-unloading station and controlled by control data, the robot delivering the evacuation tube and the pair of substrates to the evacuation tube connector and substrate magazine on the cart which is to enter the heat treating oven, sealing/cutting off the connection between the substrates and evacuation tube on the cart which has exited the heat treating oven, disposing of the remaining evacuation tube after cutting off from the substrates, and unloading finished panels which have been separated from evacuation tube;
a removal system which removes the finished panels from the loading-unloading station; and
a control system which controls operation of the carts, evacuation unit, heat treating oven, delivery system, robot, and removal system.

The systems may further include an electrical discharge gas supply unit which, during manufacture of the plasma display panel at a point in time after the evacuation process has completed and before the sealing and separating process initiates, supplies an electrical discharge gas to the space between the pair of substrates through the evacuation tube in the evacuation tube connector.

The systems may further be characterized by the evacuation unit comprising an evacuation pump, a closable open evacuation valve, and an evacuation valve controller which, when the pressure in the space between the pair of substrates has been monitored as having attained a specified level, closes the evacuation valve.

The systems may further be characterized by the aforesaid electrical discharge gas supply unit being equipped with an electrical discharge gas supply source, an open and closable supply valve through which an electrical discharge gas from the supply source may be fed to the evacuation tube, and a gas supply valve controller which closes the supply valve when the gas pressure in the region between the pair of substrates is monitored as having attained a specified pressure.

The systems may further comprise a drive mechanism capable of initiating, continuing, and terminating traversal of the carts, and a locking device which connects to the carts to secure carts to the process line following termination of their traverse.

The systems may further be characterized by the aforesaid control system actuating the operation of the robot to attach the evacuation tube to the evacuation tube connector and then to place at least the pair of substrates into the substrate magazine to simultaneously complete placement of one substrate against the evacuation tube and the loading operation of the pair of substrates to the substrate magazine.

The systems may further be characterized by the control system incorporating a supply action setting function which, to provide automatic execution of the operation through which the evacuation tube is taken from the delivery system to the evacuation tube connector on the cart, obtains positional image data indicating the cart's virtual stop position and the evacuation tube's virtual installation position, and outputs control data for the evacuation tube delivery operation executed by the robot based on the aforesaid positional image data.

The systems may further comprise a supply action setting function:
obtaining image data of virtual stop position based on preset data indicating the cart reference stop position,
correcting the cart stop position from the deviation between the virtual stop position and the reference stop position,
obtaining image data of virtual installation position based on preset data indicating the reference installation position for the evacuation tube connector from the cart stop position,
correcting the evacuation tube connector installation position from the deviation between the virtual installation position and the reference installation position,
obtaining virtual attachment position image data for the evacuation tube,
correcting the evacuation tube attachment position from the deviation between the virtual attachment position and the preset reference attachment position for the evacuation tube, and
outputting the corrected evacuation tube supply action, in the form of control data, to the robot which executes the supply action.

The systems may further be characterized by the control system incorporating an evacuation tube removal correction function which, to provide an automated operation in which a robot removes the evacuation tube from the delivery system, obtains image data indicating the virtual standby status of the evacuation tube for the removal standby position, corrects the removal operation based on the variation of data indicating the evacuation tube's virtual standby status from the preset standby status reference data, and outputs the corrected removal operation as control data.

The systems may further be characterized by the control system incorporating an evacuation tube attachment correction function which,
to provide automatic execution of an operation in which the robot attaches the evacuation tube to the evacuation tube connector,
obtains evacuation tube virtual grip status image data from the robot,
corrects the attachment operation based on the variation of preset evacuation tube grip status reference data from virtual grip status data, and
outputs the corrected evacuation tube attachment operation as control data.

The systems may further be characterized by the evacuation tube connector being structured to include an attachment orifice to which the evacuation unit is connected and into which the evacuation tube is removably inserted in a vertical orientation, and a ring seal which is installed within the attachment orifice, the ring seal being structured to form the air-tight sealing in the periphery of the evacuation tube by applying pressure against or releasing pressure from around the evacuation tube.

The systems may further comprise a vertically sliding structure which, to place the top of the evacuation tube in pressurized contact with one substrate of the pair, moves the evacuation tube connector along the vertical plane regardless of any deformation of the ring seal, and by a pressurizing device which applies pressure against the evacuation tube connector in an upward direction.

The systems may further be characterized by the substrate magazine having segmenting members defining substrate insertion spaces into which at least one pair of substrates may be inserted, and by the control system incorporating a loading determination function which, to provide automatic execution of the operation through which the pair of substrates is inserted into the substrate insertion space, obtains the dimensions of the substrate insertion space as image data, and outputs control data, based on that dimensional image data, which indicates if the pair of substrates can or cannot not be inserted into the substrate insertion space.

The systems may further be characterized by the control system incorporating a loading correction function which,
to provide automatic execution of an operation in which a robot places the evacuation tube residing in the evacuation tube connector on the cart against the ventilation port of at least one pair of substrates which has been supplied from the delivery system by the robot,
obtains image data indicating the center of the evacuation tube in the evacuation tube connector and the center of the ventilation port at the substrate pair loading standby position,
applies the center position image data to calculate the variation to the center positions of the evacuation tube and the ventilation port according to a reference loading operation previously set to the robot for supplying the pair of substrates to the substrate magazine from the loading standby position, and
outputs a corrected loading correction operation, as control data, based on the aforesaid variation.

The systems may further comprise the substrate magazine having multiple support members at multiple locations, each support member being capable of supporting at least one pair of substrates through at least one inner support piece proximal to the evacuation tube and at least one outer support piece further separated there from, the outer support piece supporting the pair of substrates with a lower frictional coefficient than the inner support piece, thereby allowing less restricted movement of the substrates placed thereon.

The systems may further be characterized by the aforesaid outer support piece being able to move with a pendulum-like action.

The systems may further be characterized by the aforesaid outer support piece being structured as a roller mechanism with its rotating axis passing through the axial center of the evacuation tube.

The systems may further comprise the control system automatically controlling the operation of an open and closable clamshell-type heater constructed of two parts able to close around the evacuation tube in order to seal off and separate the evacuation tube.

The systems may further comprise the control system automatically controlling a burner for melting the evacuation tube and an elevator device for lowering the evacuation tube connector as means of stretching the evacuation tube, in order to perform the sealing and separating operation to the evacuation tube.

The systems may further be characterized by the control system having an unloading setting function which,
to provide automatic execution of the unloading of the finished panels from the substrate magazine on the cart and their placement in the removal system,
obtains image data indicating the cart's virtual stop position and the virtual loading position of the panels, and
outputs control data, based on the aforesaid image data, which actuates the robot to unload the panels.

The plasma display panel manufacturing systems may provide installations of manufacturing plasma display panels and the like through predominantly automatic controls.

### BRIEF DESCRIPTION OF THE DRAWINGS

FIG. 1 is a schematic illustration of an example of an entire plasma display panel manufacturing system.

FIG. 2 is an explanatory schematic of the cart used in the system of FIG. 1.

FIG. 3 is a graph describing preferred temperatures in the heat treating oven.

FIG. 4 is an explanatory schematic of the evacuation unit installed to the cart shown in FIG. 2.

FIG. 5 is an abbreviated illustration of the cart traversing mechanism applied to the car shown in FIG. 2.

FIG. 6 is a vertical cross section of an example of an evacuation tube connector used in the system of FIG. 1.

FIG. 7 is an abbreviated cross section taken from plane D-D of FIG. 6.

FIG. 8 is a vertical cross section illustrating the first step of the process through which the evacuation tube is inserted into the evacuation tube connector shown in FIG. 6.

FIG. 9 is a vertical cross section illustrating the second step of the process through which the evacuation tube is inserted into the evacuation tube connector shown in FIG. 6.

FIG. 10 is a vertical cross section illustrating the first step of the process through which the substrates are placed over the evacuation tube residing in the evacuation tube connector shown in FIG. 6.

FIG. 11 is a vertical cross section illustrating the second step of the process through which the substrates are placed over the evacuation tube residing in the evacuation tube connector shown in FIG. 6.

FIG. 12 is an abbreviated lateral view of an additional preferred embodiment of the evacuation tube connector used in the system of FIG. 1.

FIG. 13 is an abbreviated lateral view illustrating the arrangement of the evacuation tubes in the tray.

FIG. 14 is an abbreviated lateral view illustrating an additional arrangement of the evacuation tubes in the tray.

FIG. 15 is a lateral view of the FIG. 6 evacuation tube connectors installed to the cart.

FIG. 16 is a plane view of the FIG. 15 evacuation tube connectors installed to the cart.

FIG. 17 is a lateral view of the obtainment of image data from the FIG. 6 evacuation tube connector.

FIG. 18 is a lateral view of a representative method of obtaining image date of the evacuation tube applied in the system of FIG. 1.

FIG. 19 is a lateral view of an additional method of obtaining image date of the evacuation tube applied in the system of FIG. 1.

FIG. 20 is an explanatory schematic illustrating the relationship between the substrate and a dimensionally distorted substrate magazine.

FIG. 21 is a flow chart illustrating the control process through which the substrate is placed in the substrate magazine.

FIG. 22 is a side view illustrating an example of a method of obtaining image data relating to the ventilation port on the substrate applied in the system of FIG. 1.

FIG. 23 is a plane view of the FIG. 22 method of obtaining image data relating to the ventilation port on the substrate.

FIG. 24 is a lateral view of an example of the substrate magazine used in the system of FIG. 1.

FIG. 25 is a plane view of the substrate magazine shown in FIG. 24.

FIG. 26 is a detail lateral view of an example of the outer support piece used by the FIG. 24 substrate magazine.

FIG. 27 is a lateral view of an additional example of the substrate magazine used in the system of FIG. 1.

FIG. 28 is a plane view of the FIG. 27 substrate magazine.

FIG. 29 is an enlarged plane view of an example of the outer support piece applied to the FIG. 27 substrate magazine.

FIG. 30 is an enlarged plane view of the FIG. 29 outer support piece.

FIG. 31 is a lateral view of the evacuation tube sealing/separating unit used in the system of FIG. 1.

FIG. 32 is a plane view illustrating the operation of the evacuation tube sealing/separating unit shown in FIG. 31.

### EXPLANATION OF THE NUMERALS

1 process line
2 cart
3 substrate
4 substrate magazine
5 evacuation tube
6 evacuation tube connector
7 evacuation unit
8 heat treating oven
9 loading-unloading station
10 substrate delivery conveyor
11 evacuation tube delivery conveyor
12 evacuation tube handling robot
13 substrate loading robot
14 evacuation tube sealing-cutting off robot
15 panel unloading robot
16 panel discharge conveyor
17 cart controller
18 oven controller
19 robot controller
20 master controller
26 locking device
27 drive bar
28 connector block
29 drive dog
33 support beam
34 support fixture
34a inner support piece
34b outer support piece
36 ventilation port
39 evacuation pump.
40 evacuation valve
42 electrical discharge gas supply unit
43 gas supply source
44 supply valve
50 pressure gauge
53 attachment orifice
54 ring-shaped seal
55 spring
56 slide guide
65 lever
72 cylindrical roller
73 support surface
S substrate insertion space
T rotational center

### DETAILED DESCRIPTION

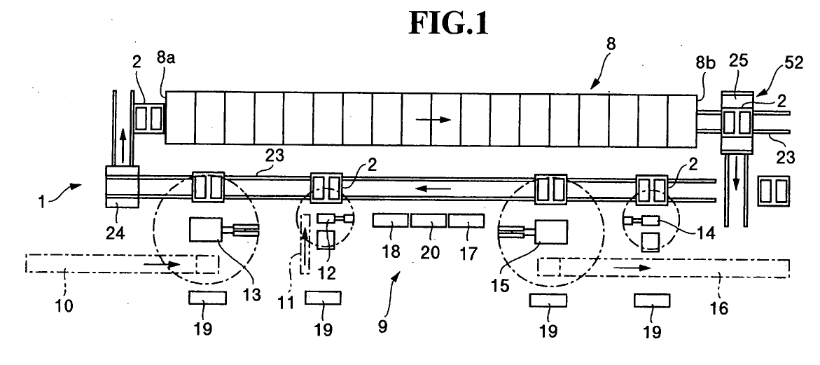

The following provides a detailed description of a representative example of a plasma display panel manufacturing system with reference to the attached drawings. As illustrated in FIGS. 1 through 4, the example of the system comprises:
a closed loop process line 1;
multiple carts 2 traversing the process line 1 in a repetitive sequential stop-and-start operation;
a substrate magazine 4 installed to each cart 2 and capable of holding at least one pair of substrates 3;
an evacuation tube connector 6 installed to the cart 2 and removably holding an evacuation tube 5 which faces the pair of substrates 3;
an evacuation unit 7 installed to the cart 2 and operating to evacuate gas through the evacuation tube 5 in the evacuation tube connector 6;
a heat treating oven 8 installed to the process line 1, the oven 8 applying a heat treatment to at least one pair of the substrates 3 on the cart 2 during traversal therein to form connections between the pair of the substrates 3 and between the substrates 3 and the evacuation tube 5, and within which gas in the space between the pair of substrates 3 is removed by the evacuation unit 7, which is installed to the cart 2, through the evacuation tube 5;
a loading-unloading station 9 provided adjacent to the heat treating oven 8 of the process line 1 along the traversing direction of the cart 2,
a delivery system comprising a substrate delivery conveyor 10 which delivers the pair of substrates 3 to the process line 1, and an evacuation tube delivery conveyor 11 which delivers the evacuation tube 5 to the process line 1;
robots 12 through 15 which are installed at the loading-unloading station 9 and which operate according to control data to deliver the evacuation tube 5 and the pair of substrates 3 to the evacuation tube connector 6 and the substrate magazine 4 respectively on the cart 2 prior to the cart 2 entering the heat treating oven 8, to seal off and separate the evacuation tube 5 after the cart 2 exists the heat treating oven 8, to remove the remaining evacuation tube 5 on the cart 2, and to unload the finished panels from which the evacuation tube 5 has been separated;
a removal system comprising a panel discharge conveyor 16 which removes the panels from the loading-unloading station 9; and
a control system comprising controllers 17-20 which control the operation of the carts 2, evacuation unit 7, heat treating oven 8, the substrate delivery conveyor 10, evacuation tube delivery conveyor 11, robots 12-15, and the panel discharge conveyor 16.

The loading-unloading station 9, which is located adjacent to the heat treating oven 8 along the cart 2 traverse path on the process line 1, primarily has the function of supplying the substrates 3 and evacuation tubes 5 to the cart 2, and of unloading the processed panels from the cart 2. The loading-unloading station 9 includes the delivery system in the form of the substrate delivery conveyor 10 which carries in a pair of frit sealed substrates 3, the evacuation tube delivery conveyor 11 which carries in the evacuation tube 5 having a frit seal 21 at its upper edge, and the removal system in the form of the panel discharge conveyor 16 which takes the processed panels out of the process line. After the cart 2 exits the heat treating oven 8, the processed panels on the cart 2 are removed, and then, new substrates 3 and evacuation tubes 5 are loaded thereon after which the cart 2 once again enters the heat treating oven 8.

The robots 12-15 which execute the previously described operations are installed along the loading-unloading station 9. More specifically, the evacuation tube handling robot 12 and substrate loading robot 13 are positioned along the entering traverse path of the cart 2 on the entrance 8a side of the heat treating oven 8 according to the assembly sequence in which the evacuation tubes 5 and substrates 3 are to be loaded on the cart 2. The evacuation tube handling robot 12 carries the evacuation tube 5 from the evacuation tube delivery conveyor 11 to the evacuation tube connector 6 on the cart 2, and the substrate loading robot 13 carries a pair of stacked substrates 3 from the substrate delivery conveyor 10 to the substrate magazine 4 on the cart 2. The evacuation tube sealing-cutting off robot 14 and panel unloading robot 15 are positioned in sequence along the leaving traverse direction of the cart 2 on the exit 8b side of the heat treating oven 8.

The evacuation tube sealing-cutting off robot 14 seals and separates the evacuation tube 5, which is connected with the substrate 3 and is used in the evacuation process to remove gasses, and then removes the separated evacuation tube 5 from the evacuation tube connector 6. The panel unloading robot 15 unloads the processed panels, which have been separated from the evacuation tube 5, from the cart 2 and carries them to the panel discharge conveyor 16. Other components also residing at appropriate locations in the loading-unloading station 9 are cart controller 17 which controls traverse of the cart 2, the evacuation unit 7, and other devices on the cart 2; oven controller 18 which controls the operation of the heat treating oven 8; robot controller 19 which controls operation of each robot; and master controller 20 which controls the operation of a whole facilities including the delivery conveyors 10 and 11 which carry in the substrates 3 and evacuation tube 5 respectively, and the panel discharge conveyor 16.

The process line 1 is set up as production equipment within a factory. The process line 1 includes parallel rails 23, upon which ride each cart 2 through multiple wheels such as the eight wheels 22, arranged in parallel pairs, and cart shuttles 24 and 25, one of each being located at each end of the rails 23, connect and transfer the cart 2 between the ends of two rail runs to form the process line 1 as a closed loop in a rectangular configuration. The heat treating oven 8 is installed over one run of the rails 23. The loading-unloading station 9 is located along the other run of the rails 23 parallel to the heat treating oven 8.

The manufacturing process operates by multiple carts 2 moving around the process line 1 in a sequential order. Each cart 2 rides on the rails 23 adjacent to the loading-unloading station 9, and as shown in the drawings, after reaching the left terminal point of the rails 23, is transferred to the rails 23 at the entrance of the heat treating oven 8, by the cart shuttle 24, from where the cart 2 moves into the heat treating oven 8. The cart 2 then moves through the heat treating oven 8, and as illustrated in the drawings, once exiting the oven 8 and reaching the right side termination of the rails 23, is transferred to the other run of the rails 23 by the cart shuttle 25, thus completing one circuit of the process line 1. In this manner, each cart 2 repeatedly starts and stops traverse between the loading-unloading station 9 and the heat treating oven 8 in a sequence coordinated with the time required for the operations to be performed.

To automate the manufacturing process, this example of the panel manufacturing system provides a motive mechanism for each cart 2, the motive mechanism being capable of initiating, continuing, and terminating the traversal of the cart 2, and further provides a locking device 26 having the purpose of securing the cart 2 to the process line 1 by detachable engagement when traverse has terminated (see FIG. 5). The motive mechanism includes a drive bar 27 movably installed along each of the rails 23 beneath the cart 2, drive bar 27 moving with repetitive for and aft strokes in the direction of the rails 23, and with repetitive opposing axial rotations at specific rotational angles. A multiple drive dogs 29 are attached to each drive bar 27, and each drive dog 29 controllably connects to or disconnects from connector block 28 installed to the bottom of each cart 2.

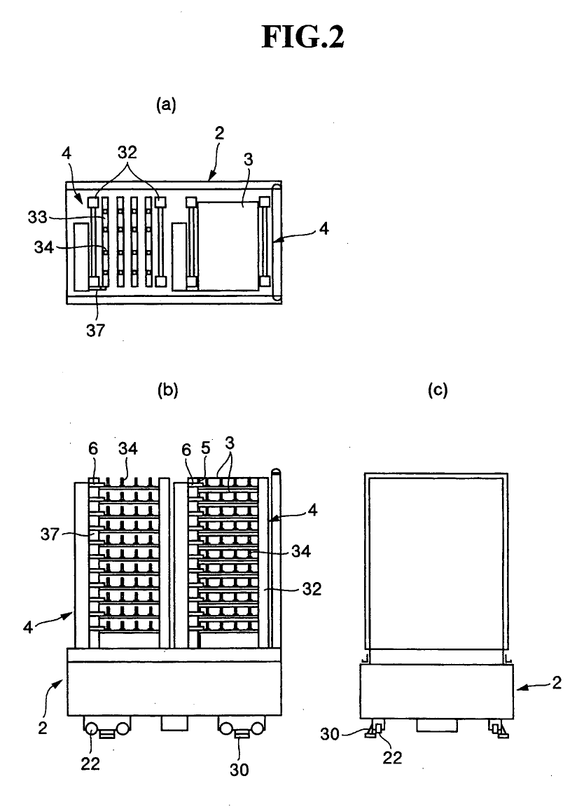

Drive bar 27 drives each cart 2 in the forward direction through the engagement of the drive dog 29 to the connector block 28 on the cart 2, with the result that all of the carts 2 are simultaneously driven forward for a specific stroke length. When the traversal of the carts 2 is to be terminated, a forward axial rotation of the drive bar 27 disconnects the drive dog 29 from the connector block 28 on the cart 2. Next, with traversal of the carts 2 being stopped, the drive bar 27 drives axially rearward and stops. The drive bar 27 then rotates in the opposite direction to engage the drive dog 29 with the connector block 28 to allow the cart 2 to be once again propelled in the forward direction. Traversal of each of the carts 2 is started and stopped in this repetitive manner, each traversal being equivalent to a specified stroke length of the drive bar 27. As shown in FIG. 2, traversal of the cart 2 is guided along the rails 23 by side guides 30 installed to the left and right sides of the cart 2.

To secure the cart 2 at its stopped position, the locking device 26, which is installed at the cart stop position, is able to move into engagement with the connector block 28. While not shown in the drawings, the locking device 26 may be structured in the form of a cylinder mechanism installed next to the rails 23, and a lock pawl 31 which is driven forward or rearward by the cylinder mechanism to engage with or disengage from the connector block 28. While the cart 2 is stationary, the cylinder mechanism drives and engages the lock pawl 31 to the connector block 28 in response to the disengagement of the drive dog 29 on the drive bar 27, and drives and disengages the lock pawl 31 from the connector block 28 in response to the engagement of the drive dog 29. This mechanism keeps the cart 2 stationary to be convenient to apply an automated control. The drive mechanism of the cart 2 may also be structured in a same manner by a self propelled mechanism through a rack and pinion.

The substrate magazine 4 on the cart 2, which is shown in FIG. 2, is structured to hold previously prepared pairs of the substrate 3, each pair being arranged in a planar stack which may be loaded onto the substrate magazine 4 in a vertical or horizontal orientation. The substrate magazine 4 shown in FIG. 2 is designed to support multiple substrates 3 in an overlapping horizontal orientation, and is structured from four support posts 32 installed to the cart 2, a plurality of support beams 33 supported by the support posts 32, and multiple support fixtures 34 protruding from the support beams 33 as means of supporting each pair of substrates 3 placed thereon.

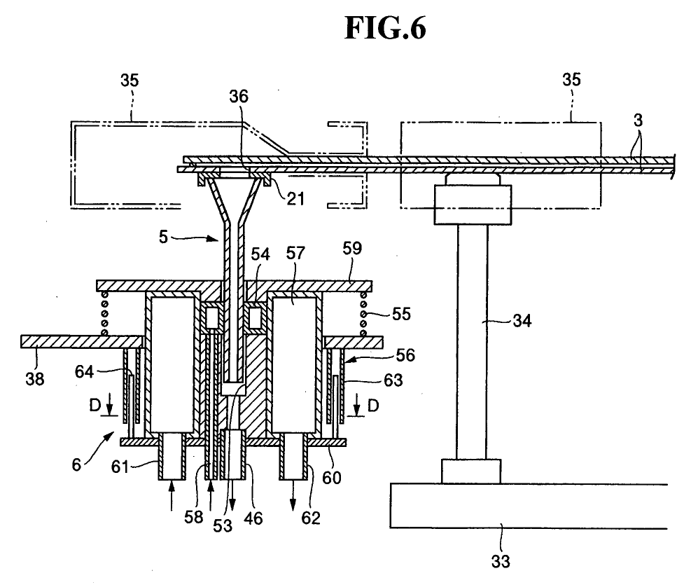

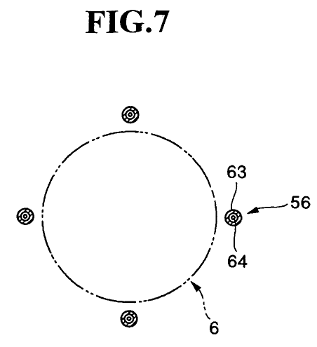

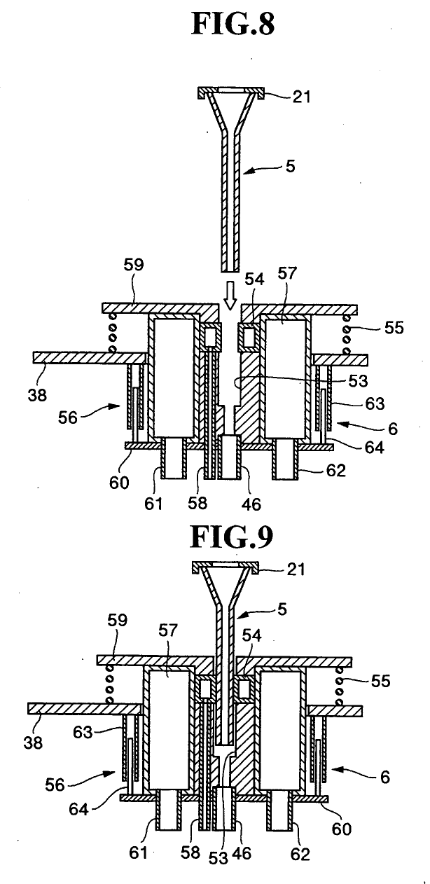

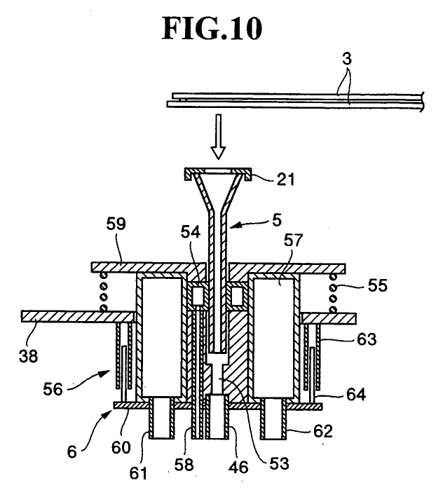

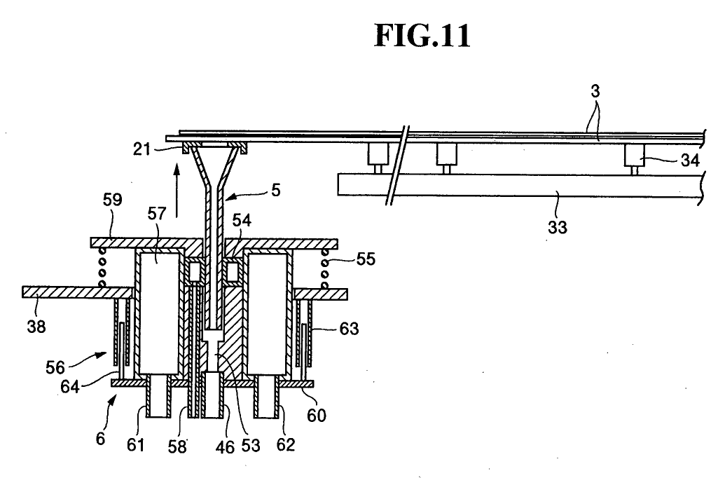

The substrate 3 made be constructed of glass, synthetic resin, metal, or other material appropriate to the task. A pair of substrate 3 is constructed and handled integrally in a stacked configuration with a frit seal applied around the external edge of one of the pair and clips 35 securing the pair, as shown in FIG. 6. The evacuation tube 5, which connects to a ventilation port 36 located in the corner of one of the substrates 3, has the purpose of guiding the evacuation of gasses from between the substrates 3 within the heat treating oven 8, and also of guiding the introduction of an electrical discharge gas to between the substrates 3, after the aforesaid gasses have been evacuated, during the plasma display panel manufacturing process.

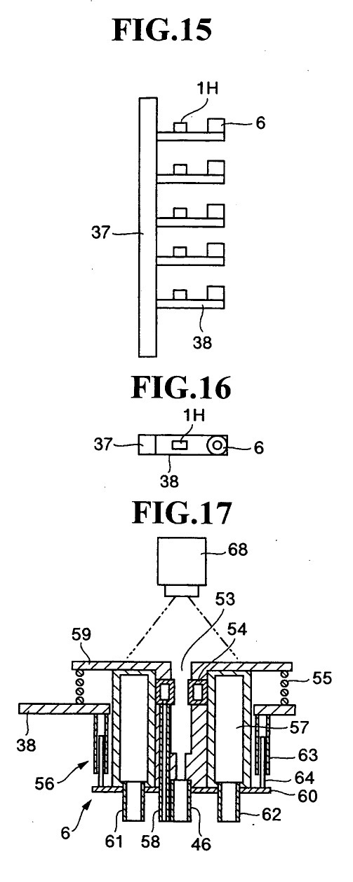

A number of evacuation tube connectors 6 are installed to each cart 2 equivalent to the number of pairs of substrates 3 to be loaded thereon. As illustrated in FIG. 15, one connector pillar 37 is installed in the vicinity of ventilation port 36 formed in the substrate 3 at a location external to the substrate magazine 4, and projecting members 38, each to which an evacuation tube connector 6 is attached, are installed one above the other in the vertical direction along the height of the connecting pillar 37. The evacuation tube 5 is removably attached to the evacuation tube connector 6. The upper portion of each evacuation tube 5 extends upwardly toward each pair of substrates 3 supported on the support fixtures 34 to face to the each lower side substrate 3 into which the ventilation port 36 is formed, and the lower portion thereof extends downward into the evacuation tube connector 6. A frit seal 21 is applied at the upper end of the evacuation tube 5 facing the substrate 3.

The evacuation tube handling robot 12 and substrate loader robot 13 place the evacuation tubes 5 and substrate pairs 3 onto the cart 2 through an automatically controlled supply operation. The robot controller 19 manages this supply operation so that the robot 12 attaches one evacuation tube 5 to the evacuation tube connector 6 after which the robot 13 places one pair of substrates 3 into the substrate magazine 4, for the purpose of completing an assembly that evacuation tube 5 faces the substrate pair 3 along with the loading operation of the substrate pair 3 to the substrate magazine 4.

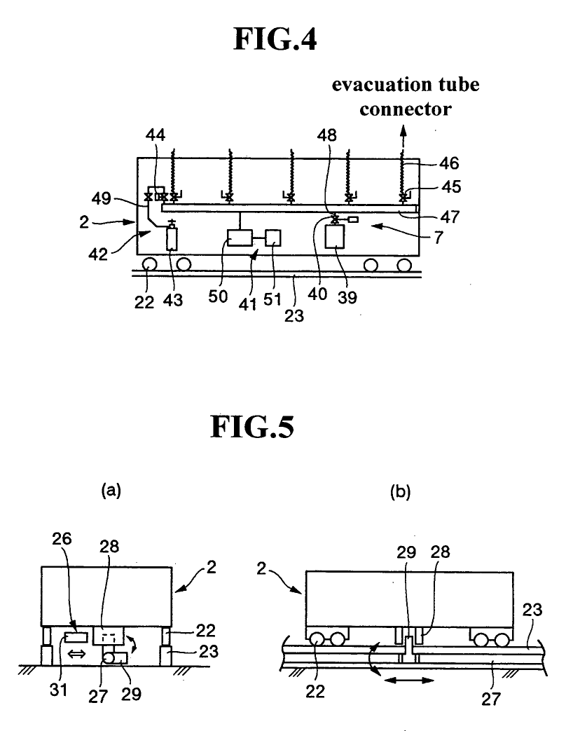

Each evacuation tube connector 6 is connected with the evacuation unit 7, which is installed to the cart 2, for the purpose of evacuating gasses, through the evacuation tube 5, from the space between the two substrates 3 forming the pair. The gas evacuation operation is executed while the cart 2 traverses through the heat treating oven 8. As illustrated in FIG. 4, the evacuation unit 7 comprises evacuation pump 39, open and closable evacuation valve 40 which opens to allow gas evacuation, and controller 41 which closes the evacuation valve 40 when the pressure between the two substrates 3 of the pair reaches a specific value. This structure thus allows the evacuation process to be executed automatically.

If necessary, an electrical discharge gas supply unit 42 may be installed to the cart 2 in order to introduce an electrical discharge gas into the space between the pair of substrates 3 during the plasma display panel manufacturing process. The electrical discharge gas may be introduced, after the completion of the evacuation process and before sealing and cutting off the evacuation tube 5 through which the gas has been evacuated, while the evacuation tube 5 is connected to the evacuation tube connector 6. The electrical discharge gas supply unit 42 comprises gas supply source 43, supply valve 44 which opens or closes to allow or prevent the flow of the electrical discharge gas from the gas supply source 43 to the evacuation tube 5, and controller 41 which closes the supply valve 44 when the pressure in the space between the substrates 3 of the pair reaches a specific value. This structure allows the electrical discharge gas delivery operation to be controlled automatically. A hollow panel may be provided for a process which does not require the introduction of an electrical discharge gas.

A header 47 is connected to each evacuation tube connector 6 through an individual pipes 46 to which a solenoid valve 45 is installed, the evacuation pump 39 is connected to the header 47 through an exhaust gas pipe 48 to which the evacuation valve 40 is installed, and the gas supply source 43 is connected to the header 47 through a gas supply pipe 49 to which the supply valve 44 is installed. The header 47 is provided for the purpose of proceeding continuously the evacuation process and electrical discharge gas introducing process to a multiplicity of substrate pairs 3 simultaneously by one evacuation pump 39 and one gas supply source 43. The controller 41 is structured from a pressure gauge 50 and a control module 51. A pressure gauge 50 is installed to the header 47 to monitor the pressure between each pair substrates 3. A monitoring signal from the pressure gauge 50 is output to the control module 51 which controls the operation of each evacuation valve 40, supply valve 44, and the evacuation pump 39.

When the evacuation valve 40 and solenoid valve 45 of the individual pipes 46 open in evacuation process, the space between the substrates 3 becomes continuous to the evacuation pump 39, thereby resulting in the atmosphere of the space being evacuated at a pressure of from 10⁻⁴˜10⁻⁷ Torr. The electrical discharge gas is introduced after the evacuation pump 39 operation terminates and the evacuation valve 40 closes and further the supply valve 44 opens, thereby resulting in the electrical discharge gas, which may be Neon, Argon, Xenon or other appropriate gas, flowing from the gas supply source 43 into the space between the substrates 3 at a pressure of from 400˜700 Torr.

A purging process may be applied in addition to the gas evacuation wherein a purge gas supply pipe is connected to the header 47 through a solenoid valve (not shown in the drawings), the solenoid valve operating to connect the purge gas supply pipe to either to the exhaust gas pipe 48 or gas supply pipe 49. When the purging process is employed, the atmosphere between the substrates 3 is evacuated at the beginning of the gas evacuation process after which the purge gas may be introduced, and then gas evacuation process may be executed again.

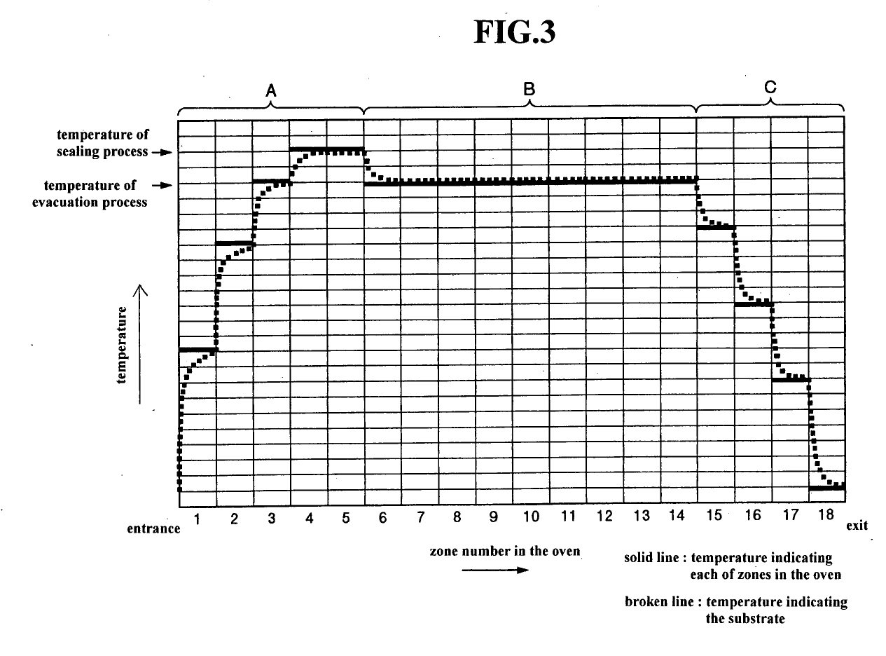

As illustrated in FIG. 3, while moving from the entrance 8a to the exit 8b in the heat treating oven 8, the cart 2 passes through three different processing zones consisting of sealing process block ‘A’, evacuation process block ‘B’, and cooling process block ‘C’. The temperature within each processing block A˜C differs in order to conduct the desired heat treating operation in which each traversing cart 2 passes through the controlled temperature environment within each processing block A˜C. Because the cart 2 traverses the rails 23 placed underneath the floor of the heat treating oven 8, an open space exists along the entire length of the oven floor. An insulating material member installed to each cart 2 seals the open space, and the continual traverse of multiple adjacently aligned carts 2 along the rails 23 forms a mechanism able to seal the open space in the floor of the heat treating oven 8.

A radiant tube burner, electric heater, or other thermal energy source is installed within a circulation passage defined by a circulation flow generating baffle within the sealing process block ‘A’ in which the environment temperature gradually rises to the sealing temperature along the length of block A, and within the evacuation process block ‘B’ in which the constant environment temperature is slightly below the sealing temperature. The environment within the heat treating oven 8 is heated by the aforesaid thermal energy source and circulated by a fan as means of applying thermal energy to the substrates 3 and so forth. The external atmosphere introducing opening, cooling tube, or other cooling source is installed, in addition to the same thermal energy source installed in the block ‘A’ or ‘B’, within the cooling process block ‘C’. In the sealing process block ‘A’, the frit seal melts to connect the pair of substrates 3 for sealing the space thereof and to fix the evacuation tube 5 to either one of the substrates 3. In the evacuation process block ‘B’, the evacuation unit 7 operates to evacuate the atmosphere between the substrates 3 through the evacuation tube 5. An electrical discharge gas insertion region 52 is provided between the exit 8b of the heat treating oven 8 and the extraction cart shuttle 25 in order to introduce the electrical discharge gas between the substrates 3.

The following will describe a preferred automated control structure for the panel manufacturing process. A preferred structure of the evacuation tube connector 6, to which the evacuation tube 5 is attached under automatic control, will be described as well as a preferred structure for the support of the evacuation tube 5 held therein in light of the effects of the heat treatment conducted in the heat treating oven 8.

As illustrated in FIGS. 6˜11, the center section of the evacuation tube connector 6 includes an attachment orifice 53 which connects to the evacuation unit 7 through the pipe 46, which faces upward in order to allow for the connection of the evacuation tube 5 thereto, and which accommodates the installation of an elastic ring-shaped seal 54 therein which applies pressure against and supports the evacuation tube 5 while sealing the periphery of the tube 5 from the external environment. The evacuation tube connector 6 further includes a vertically sliding structure, in the form of a slide guide 56, which may form a pressurized connection, regardless of any distortion of the seal 54, against the pair of substrates 3 at the upper end of the evacuation tube 5 by slidably supporting the connector 6 vertically, and a pressurizing device in the form of spring 55 which applies upward pressure to the evacuation tube connector 6.

With the lower portion of the evacuation tube 5 attached to the evacuation tube connector 6 and the upper end thereof pressurized against the substrate 3, the evacuation tube 5 bonds to the ventilation port 36 as a result of the heated environment within the heat treating oven 8. This is followed by initiation of the evacuation process in which the atmosphere between the substrates 3 is evacuated through the evacuation tube 5 fixed to the evacuation tube connector 6. With the upper end of the evacuation tube 5 in contact with the substrate 3, and with the evacuation tube 5 maintained under pressure, the application of heat to the connection forms a welded seal between the evacuation tube 5 and substrate 3.

The evacuation tube connector 6 is additionally equipped with a ring-shaped cooling jacket 57 installed around the ring-shaped seal 54 with the purpose of cooling the seal 54 during the heat treating process, an air supply/evacuation pipe 58 connected to the internal space of the seal 54, and upper and lower plate members 59 and 60 between which the aforesaid components reside within a sandwich-like structure. The entire evacuation tube connector 6 is supported in a vertically movable condition by a projecting member 38 through the spring 55 mounted beneath the upper plate member 59, projecting member 38 being a cantilevered member extending from the connector pillar 37. Element 61 is a coolant supply pipe, and element 62 is a coolant discharge pipe. The upper portion of the evacuation tube 5 is formed as a funnel shape, and the lower portion, which is of uniform diameter, extends to a specific position within the attachment orifice 53 through an opening in the upper plate member 59 and through the ring-shaped seal 54. With the evacuation tube 5 installed within the evacuation tube connector 6, high pressure air supplied through the air supply/evacuation pipe 58 to the internal space of the seal 54 has the effect of expanding the seal 54 to form an air-tight seal around the evacuation tube 5. Mechanical means may also be used to expand and contract the seal 54.

A frit seal 21 is applied to the upper end of the evacuation tube 5 before its lower portion is inserted into the attachment orifice 53 in the evacuation tube connector 6. The upper end of the evacuation tube 5 is positioned 1˜2 mm above the lower surface of the substrate 3 which may be loaded in a horizontal orientation on the support fixture 34. High pressure air, which is then supplied to the internal region of the ring-shaped seal 54 through the air supply/discharge pipe 58, swells the seal 54 which grips the evacuation tube 5 and thus secures it in the evacuation tube connector 6.

Following the mounting of the evacuation tube S in the evacuation tube connector 6, the substrate 3 is loaded on the cart 2 while the ventilation port 36 simultaneously connects to the evacuation tube 5. Because the evacuation tube S is secured in the evacuation tube connector 6 with its upper end extending above the lower surface of the substrate 3, the loading of the substrate 3 pushes the evacuation tube connector 6 downward against the tension of the spring 55, thus forming a pressure-formed seal between the upper end of the evacuation tube 5 and the lower surface of the substrate 3. With the evacuation tube 5 mechanically pressurized against and air-tightened to the evacuation tube connector 6, the cart 2 enters the heat treating oven 8 where the sealing and evacuation processes will be executed. Because the heated environment forms a welded seal between the substrate 3 and evacuation tube 5 with the two components in mutual pressurized contact, a secure leak-proof bond is formed, a distortion of the evacuation tube 5 does not arise during the sealing and evacuation processes, and it allows the subsequent cutting-off process to be executed more efficiently. For these reasons, this structure is highly appropriate for an automatic sealing and separation operation to the evacuation tube 5.

While it is preferable that the positional relationship between the evacuation tube 5 and substrate 3 remain stable during traversal of the cart 2 and also during the sealing and evacuation operations, the forces of vibration, impact, and thermal expansion and contraction may result in positional changes. For example, excessive force being applied by the ring-shaped seal 54 against the evacuation tube 5 may result in overcoming the strength of the connection between the evacuation tube 5 and substrate 3. This may lead to problems which could possibly interfere with the sealing process, problems such as the evacuation tube 5 inclining or breaking, or separation of the frit seal 21 from the lower surface of the substrate 3. Moreover, if the relative horizontal positions of the evacuation tube connector 6 and the substrate 3 were to be disturbed, there is a possibility that the evacuation tube connector 6 would not shift in parallel with the substrate 3, but incline relative thereto. It must be taken into consideration that an excessive unfavorable rotational or bending force applied to the evacuation tube 5 could cause it to incline or break in a way which would render the sealing process inoperable.

While the drawings describe the evacuation tube connector 6 as being supported by the projecting member 38 through the spring 55 installed beneath the upper plate member 59, this structure must be carefully considered in terms of the previously noted problems regarding the evacuation tube 5.

To solve the aforesaid problems, a slide guide 56 is installed between the projecting member 38 and the lower plate member 60. The slide guide 56 is constructed of a hollow cylinder 63 whose internal surface is made from carbon or other low friction material, and a rod 64 which slides within the cylinder 63. The cylinder 63 is secured to and supported by the underside of the projecting member 38, and the rod 64 is installed to the lower plate member 60. The slide guide 56 limits the movement of the evacuation tube connector 6 to the vertical plane while restricting it along the horizontal plane relative to the projecting member 38.

When the substrate 3 is put onto and the weight of the substrate 3 presses the evacuation tube connector 6 downward a small amount along a path guided by the slide guide 56, a mechanism which allows the evacuation tube 5 to be displaced only along the vertical axis while preventing movement along the horizontal plane. The operation of the slide guide 56 and the mechanism by which the evacuation tube connector 6 and evacuation tube 5 are pressed to the substrate 3 by the spring 55 have the effect of maintaining a high level of friction between the frit seal 21 and the substrate 3, which, in regard to the sealing process, prevents movement in the joint formed between the ventilation port 36 and evacuation tube 5 when the heated substrate 3 expands against the evacuation tube 5 located at and pressed to the ventilation port 36. Moreover, in regard to the sealing process, even though the substrate 3 may be warped, the slide guide 56 has the effect of firmly pressurizing the evacuation tube 5, by the spring 55, in an upward direction to prevent the separation of the substrate 3 and frit seal 21.

Therefore, because this structure allows the sealing process to be conducted without a clip 35 holding the substrates 3 and evacuation tube 5 together, the effects of vibration and shock which may be applied to the evacuation tube 5 and substrates 3 at the timing of entering into the heat treating oven 8 are lessened, dimensional distortion which can result from the thermal expansion and contraction of components during the evacuation and evacuating processes (especially side loads that would tend to rotate the evacuation tube 5) is prevented, and the damage to the evacuation tube 5 and the scarring which can be inflicted by the use of the clip 35 is eliminated, thus simplifying preparatory work for the sealing process and improving overall reliability. The pressurized support of the evacuation tube 5 is easily maintained because the evacuation tube connector 6 is supported by the spring 55 to be movable only along the vertical plane, and because the evacuation tube 5 is pressurized to the substrate 3 and supported in a vertical orientation in a manner which prevents its reaction to forces applied from directions other than the vertical.

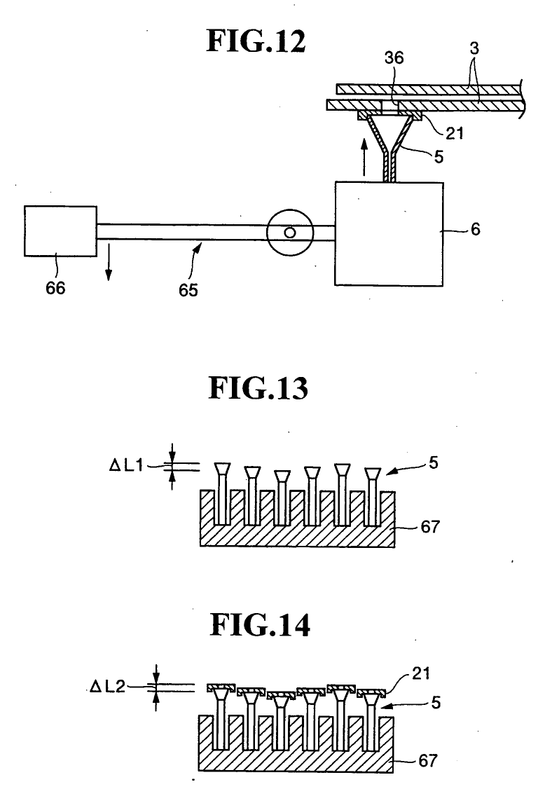

As shown in FIG. 12, a pressurizing device other than the spring 55 may be employed to apply pressure to the evacuation tube connector 6. This device may be, for example, a weighted lever mechanism in which a counterweight 66 is attached to one end of a lever 65 with the other end connecting to and pressing upward against the evacuation tube connector 6.

The following will describe the automated control operation through which the evacuation tube 5 is connected to the evacuation tube connector 6. In order to take the evacuation tube 5 from the evacuation tube delivery conveyor 11 to the evacuation tube connector 6 on the cart 2, the control system including the robot controller 19 to control the evacuation tube handling robot 12 and so on, has a supply action setting function obtaining virtual stop position image data for the cart 2 and virtual attachment position image data relating to the position of the evacuation tube 5 in the evacuation tube connector 6 and outputting control data, based on these image data, for the evacuation tube delivery operation conducted by the evacuation tube handling robot 12.

The supply action setting function obtains image data of virtual stop position based on preset data indicating the cart 2 reference stop position,
corrects the cart 2 stop position from the deviation between the virtual stop position and the reference stop position,
obtains image data of virtual installation position based on preset data indicating the reference installation position for the evacuation tube connector 6 from the cart 2 stop position,
corrects the evacuation tube connector 6 installation position from the deviation between the virtual installation position and the reference installation position,
obtains virtual attachment position image data for the evacuation tube 5,
corrects the evacuation tube 5 attachment position from the deviation between the virtual attachment position and the preset reference attachment position for the evacuation tube 5, and
outputs the corrected evacuation tube supply action, in the form of control data, to the evacuation tube handling robot 12 which executes the supply action.

The control system, including the robot controller 19 to control the evacuation tube handling robot 12, in order to provide automatic execution of the operation through which the evacuation tube handling robot 12 removes the evacuation tube 5 from evacuation tube delivery conveyor 11 in the delivery system, includes an evacuation tube removal correction function which
obtains virtual standby status image data for the evacuation tube 5 at the removal standby position,
corrects the removal operation based on the variation of virtual standby status data from preset standby status reference data for the evacuation tube 5, and
outputs the corrected removal operation as control data.

The control system, including the robot controller 19 to control the evacuation tube handling robot 12, in order to provide automated control of the operation in which the evacuation tube handling robot 12 attaches the evacuation tube 5 to the evacuation tube connector 6, includes an evacuation tube attachment correction function which
obtains image data relating to the virtual status of the grip of the evacuation tube handling robot 12 on the evacuation tube 5,
corrects the attachment operation based on the deviation of virtual grip status data from preset grip status reference data, and
outputs the corrected attachment operation as control data.

Regarding the operation through which the evacuation tube 5 is carried into the loading-unloading station 9 by the evacuation tube delivery conveyor 11 and delivered to the evacuation tube connector 6, the evacuation tubes 5 are initially prepared for delivery by their vertical placement in a tray 67 as illustrated in FIG. 13, and, if necessary, by having a frit seal 21 applied on the top end of each as illustrated in FIG. 14. An evacuation tube 5 is then inserted into the attachment orifice 53 in the evacuation tube connector 6. As the evacuation tubes 5 are of an easily breakable glass material and may exhibit variations in their dimensions, the length of each evacuation tube 5 is not uniform, and, as shown in FIG. 13, may vary by ΔL1 (standard length plus or minus 1 mm). With the frit seals 21 applied to the tops of the evacuation tubes 5, as shown in FIG. 14, variation between the lengths of the evacuation tubes 5 with applied frit seals 21 are shown as ΔL2. It is required, however, that the upper surface of the evacuation tube connector 6 and that of the evacuation tube 5 are at a uniform level.

For these reasons, the operation through which the evacuation tube 5 is attached to the evacuation tube connector 6 has been done by hand as follows. First, one evacuation tube 5 is manually removed from the tray 67 and placed in the attachment orifice 53 in the evacuation tube connector 6 through visual examination by a technician. The height of the evacuation tube is then adjusted so that the distance between the upper surface of the evacuation tube connector 6 and the upper edge of the evacuation tube 5 remains uniform. Lastly, the evacuation tube 5, having its installation height already adjusted, is sealed in the evacuation tube connector 6 through the introduction of high pressure air into the ring-shaped seal 54. This procedure, however, is not very efficient nor is it productive as a result of the manual operation through which the evacuation tube 5 is connected to the evacuation tube connector 6. It is preferable to introduce an automatic control completing a series of operation for assembling the evacuation tube 5 to the evacuation tube connector 6 by means of the automated evacuation tube handling robot 12.

In this case, after the cart 2 stops in front of the evacuation tube handling robot 12, which is at a specific static position, the installation operation is initiated. Even though a reference stop position has been established, the cart 2 is not always able to physically stop at that position. Moreover, the position of the attachment orifice 53 in the evacuation tube connector 6 will shift due to the tendency of the evacuation tube connector 6 and substrate magazine 4 on the cart 2 to distort in the heat treating oven 8 during the sealing and evacuation processes. In addition, when the evacuation tube 5 is inserted into the attachment orifice 53, due to the difference in the height of the evacuation tube connector 6, it becomes difficult to maintain the evacuation tube 5 in the correct condition in the evacuation tube connector 6. Therefore, the following measures must be taken to automate this process.

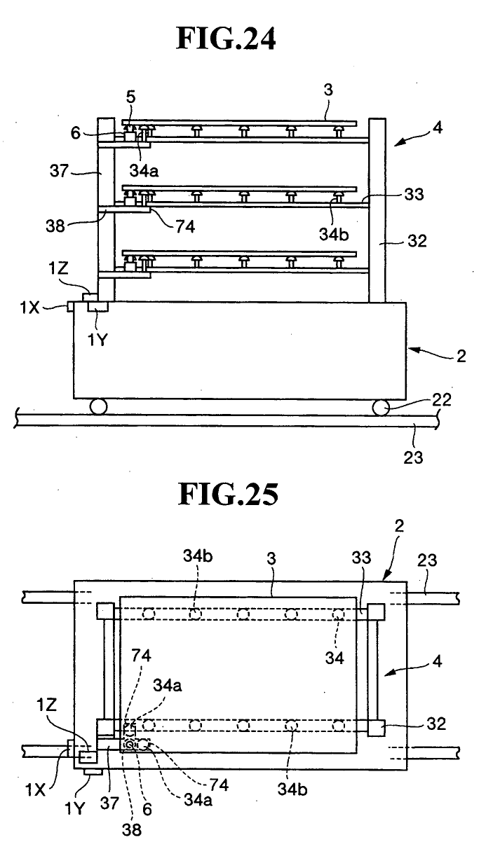

As illustrated in FIGS. 24 and 25, reference markers 1X, 1Y, and 1Z are installed at the corner of the cart 2, marker 1X indicating a reference point for the position of the cart 2 on the horizontal X-axis parallel to the rails 23, marker 1Y indicating a reference point for the position of the cart 2 on the horizontal Y-axis perpendicular to the rails 23, and marker 1Z indicating a reference point for the position of the cart 2 on the vertical Z-axis perpendicular to both the X and Y-axes, in other words, the position of the cart 2 along its height. Moreover, as illustrated in FIGS. 15 and 16, a reference marker 1H is installed to each projecting member 38 on the connecter pillar 37 of the cart 2 as means of indicating reference positions for the projecting members 38. The reference markers 1X, 1Y, and 1Z may be formed as integral parts of the cart 2, or may be separate components attached thereto. In the same manner, the reference marker 1H may be integrally formed to each projecting member 38, or may be attached thereto as a separate component.

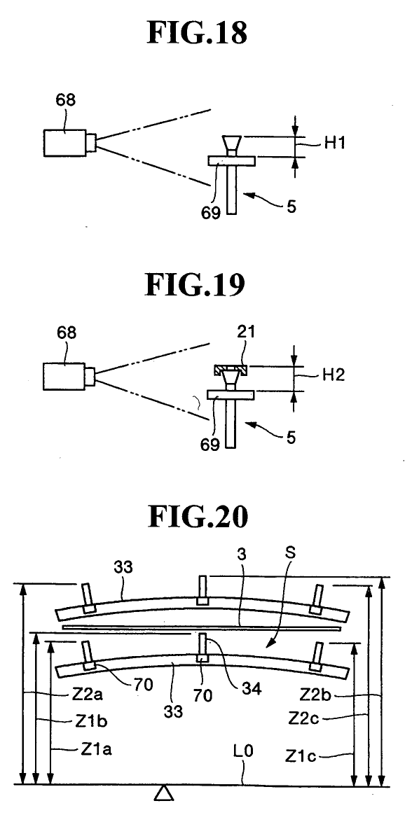

The evacuation tube handling robot 12, which is installed at a static position at the loading-unloading station 9, has an arm capable of three-dimensional positioning through linear and rotational movements. A camera 68 is attached to the arm as means of providing various types of control data, in the form of image data, and as illustrated in FIG. 17, is capable of monitoring the position of the attachment orifice 53 of the evacuation tube connector 6. The robot arm executes a first operation through which the coordinates for the center of the attachment orifice 53 are established, and a second operation through which the evacuation tube 5 in the tray 67 is gripped and inserted into the attachment orifice 53. In the second operation, as illustrated in FIGS. 18 and 19, the top end of the evacuation tube 5, which is gripped in the chuck 69 of the robot arm, is monitored by the camera 68 to measure the distance from the chuck 69 to the top end of the evacuation tube 5, or the distance from the chuck 69 to the top of the frit seal 21 in case of being applied the frit seal 21 to the evacuation tube 5.

The operation (step 1) through which the evacuation tube 5 is inserted into the evacuation tube connector 6 begins, when the cart 2 moves to a position in front of the evacuation tube handling robot 12 where the deviations (Δx1, Δy1, and Δz1) between the cart 2 reference stop position and virtual stop position are calculated based on the monitoring of the reference markers 1X, 1Y and 1Z by the camera 68. Based on the calculated deviations (Δx1, Δy1, and Δz1), the correction is executed for the first measured position which is the robot arm's first reference stop position. For example, if the X-axis deviation component is +ΔX, the robot arm stroke for the X-axis is lengthened only by ΔX. Conversely, if the X-axis deviation component is −ΔX, the robot arm stroke for the X-axis is shortened only by ΔX. The correction for the Y-axis and Z-axis are conducted in the same manner. Therefore, even though there may be an error in the cart 2 virtual stop position, the first measured position of the robot arm is corrected to a position where the camera 68 can monitor the reference marker 1H on the projecting member 38.

The next operation (step 2) takes place with the robot arm having stopped at the corrected first measured position. The reference marker 1H on the projecting member 38 is monitored by the camera 68, and the deviations (Δx2, Δy2, and Δz2) are calculated between the reference installation position for the evacuation tube connector 6 (the center of the attachment orifice 53) and the virtual installation position. In the same manner, based on the calculated deviations (Δx2, Δy2, and Δz2), the correction is executed for the second measured position which is the robot arm's second reference stop position. Therefore, even though there may be an error in the evacuation tube connector 6 reference installation position, the second measured position of the robot arm is corrected to a position where the camera 68 can monitor the center of the attachment orifice 53.

The next operation (step 3) takes place with the robot arm having stopped at the corrected second measured position. As illustrated in FIG. 17, the camera 68 then moves to and monitors the center of the attachment orifice 53, and the deviations (Δx3, Δy3, and Δz3) are calculated between the attachment orifice 53 reference center position and the virtual center position. These three operations (steps 1 through 3) determine the correct position (on the X, Y, and Z-axes) at which the robot arm will stop over the evacuation tube connector 6 when the evacuation tube 5 is to be attached.

Meanwhile, determination of the descending stop position (X, Y, and Z1), that is, the setting of the position to which the robot arm moves from the previous stop position (X, Y, and Z), is based on data indicating the height of the evacuation tube connector 6 on the Z-axis and data indicating the virtual length of the evacuation tube 5 (the grip target) or the virtual length of the evacuation tube 5 with the frit seal 21 attached. For example, if the position at which the evacuation tube 5 is gripped by the robot arm's chuck 69, that is, the robot arm stop position, is determined as a constant, the distance H1 from the chuck 69 to the top end of the evacuation tube 5, or the distance H2 from the chuck 69 to the top of the frit seal 21 is measured (see FIGS. 18 and 19), and a calculation is executed to determine the deviation (ΔL) between the reference length and virtual length of the evacuation tube 5. FIG. 18 illustrates the evacuation tube 5 in attachment orifice 53 without a frit seal 21 applied, and FIG. 19 illustrates the evacuation tube 5 in the attachment orifice 53 with the frit seal 21 applied.

Therefore, the determination of the robot arm's descending stop position (X, Y, and Z1) in relation to the virtual length of the evacuation tube 5 is based on data indicating the deviation (ΔL) on the evacuation tube 5 and data indicating the height of the evacuation tube connector 6 on the Z axis. For example, if the deviation (virtual length minus reference length) between the virtual length of the evacuation tube 5 and its reference length is determined as +ΔL, the descending stop position of the robot arm will be a point only ΔL lower from a position of zero (0) deviation, and the upper end of the evacuation tube 5, or the frit seal 21, will become an uniform relationship with the height of the evacuation tube connector 6.

In the previously noted example, while the position of the top of the evacuation tube 5, or the top of the frit seal 21, is measured after the evacuation tube 5 is gripped by the chuck 69, the position of the top of the evacuation tube 5 or frit seal 21 may also be obtained by a measurement performed before the evacuation tube 5 is gripped by the chuck 69. In this case, the position of the top of the evacuation tube 5, or frit seal 21, may be previously measured by the camera 68 before the evacuation tube 5 is gripped by the chuck 69, the position at which the chuck 69 grips the evacuation tube 5 is corrected based on data indicating that top position, and the descending stop position of the robot arm is revised based on data indicating the height of the evacuation tube connector 6.

This type of control of the evacuation tube handling robot 12 makes it possible to align the evacuation tube 5 with the attachment orifice 53, adjust it in the correct position in regard to its length, and accurately insert it into the attachment orifice 53. This can be done even with an error in the cart 2 virtual stop position, the presence of manufacturing process deviations, variations of the center position of the attachment orifice 53 in the evacuation tube connector 6 resulting from thermal distortion of the projecting member 38, and variations in the length of the evacuation tubes 5 due to loose manufacturing tolerances. Moreover, the camera 68 initially monitors the large variations in the cart 2 stop position, and then monitors the small variations in the center position of the attachment orifice 53. Even if a field of vision on the camera 68 may be narrow, the center of the attachment orifice 53 is accurately monitored by way of narrowing down a detection area, thus aiding the operation through which the evacuation tube 5 is inserted into the attachment orifice 53.

The following will describe a preferred structure of the automatic control mechanism through which the substrates 3 are loaded onto the cart 2 on which the evacuation tube 5 has been attached to the evacuation tube connector 6. The substrate magazine 4 incorporates multiple substrate insertion spaces ‘S’, which are defined by multiple segmenting members in the form of support beams 33, each insertion space ‘S’ capable of accommodating the insertion of one pair of substrates 3. To automatically control the operation of the substrate loading robot 13 in loading each pair of substrates 3 into the substrate magazine 4, the control system, which includes the robot controller 19 to control the substrate loading robot 13 and so on, utilizes a loading determination function which obtains image data indicating the dimensions of the insertion space ‘S’, and which outputs a “go” or “no go” control data, based on the data relating to the aforesaid dimensions, to indicate if the pair of substrates 3 can or cannot be loaded into the substrate insertion space ‘S’.

The control system, including the robot controller 19 for controlling the substrate loading robot 13, incorporates a loading correction function which, in order to have the ventilation port 36 of at least one pair of substrates 3 (which are supplied from the substrate delivery conveyor 10 through the substrate loading robot 13) be brought into alignment with the evacuation tube 5 in the evacuation tube connector 6 on the cart 2 by means of automatic control,
obtains image data indicating the center of the evacuation tube 5 in an attached condition to the evacuation tube connector 6 and indicating the center of the ventilation port 36 at the loading standby position for the pair of substrates 3,
applies the aforesaid center position data to calculate the variation to the center positions of the evacuation tube 5 and the ventilation port 36 according to a reference loading operation previously set to the substrate loading robot 13 for supplying a pair of substrates 3 to the substrate magazine 4 from the loading standby position, and
outputs the corrected loading operation as control data based on the aforesaid variation.

With the positioning space for the support beam 33 noted as ‘D’ and the height of the support fixture 34 noted as ‘h’, the substrate insertion space ‘S’ in which the pair of substrates 3 is inserted between the upper surface of the support fixture 34 and the lower surface of the support beam 33 has a vertical dimension of ‘D’ minus ‘h’ (D-h). Moreover, in regard to the placement of the substrate 3 on the support fixture 34, it is essential that the centerline of the ventilation port 36 in the corner of the substrate 3 is aligned with the centerline of the evacuation tube 5.

Because the support post 32 and support beam 33 are subject to thermal distortion induced by the sealing and evacuation processes taking place in the heat treating oven 8, the dimensions of the space between the upper surface of the support fixture 34 and the lower surface of the support beam 33 may change from the previously noted (D-h) dimension, thus resulting in disproportionate values. Also, the position of the attachment orifice 53 in the evacuation tube connector 6, that is, the position of the centerline of the evacuation tube 5 mounted to the evacuation tube connector 6, may also fall out of alignment due to variations in the cart 2 stop position as well as the previously noted thermal distortion. Furthermore, the position of the ventilation port 36 in the substrate 3 may also be out of alignment due to dimensional variations in the manufacturing process. As a result of these factors, conventional processes load the substrate 3 onto the cart 2 manually, an operation which results in poor process efficiency and reduced productivity. The system uses the substrate loading robot 13 to automate this process by the robot arm supporting the substrate 3, carrying it into the substrate insertion space ‘S’, and placing it on the support fixture 34.

It must be considered, however, that damage could result from a collision between the substrate 3 and support fixture 34, or between the robot arm and support beam 33, if the size of the substrate insertion space ‘S’ (D-h) has been reduced to the point where there is insufficient vertical space in which the substrate 3 insertion is induced. It must also be considered that, even though the robot arm carries the substrate 3 to the same exact position, a variation of the cart 2 stop position will result in misalignment between the center of the ventilation port 36 on the substrate 3 and the center of the evacuation tube 5.

The substrate loading robot 13 is positioned at the loading-unloading station 9 adjacent to the rails 23, and as illustrated in FIG. 20, a reference marker 70 is installed at three locations on the outer side of each of the support beams 33 which are installed in a vertical step-like orientation on the cart 2. The reference marker 70 may be formed as an integral part of the support beam 33, or may be attached to the support beam 33 as a separate component. The evacuation tube 5 is inserted into each evacuation tube connector 6 on the cart 2 by the evacuation tube handling robot 12. The reference markers 70 are monitored by the camera (not shown in the drawings) mounted to the robot arm of the substrate loading robot 13, the virtual height of each support beam 33 is measured, and the loading operation, through which the substrate 3 is loaded onto the cart 2, is executed as explained below.

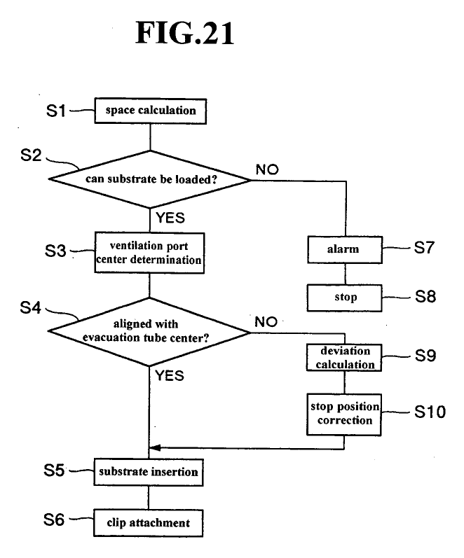

As illustrated in the FIG. 21 flow chart, in ‘Step S1’ of the process, a calculation is conducted based on the height of the reference markers 70, as monitored by the camera, in order to determine the dimensions of the each space between the lower surface of the support beam 33 and the support fixture 34 beneath it. To be more specific, to determine the positions of the first and second support members for example, as illustrated in FIG. 20, height dimensions Z1a, Z1b, Z1c, and Z2a, Z2b, Z2c from a reference level L0 corresponding to the upper surfaces of first and second support fixtures 34 are calculated according to the height of each monitored reference marker 70, after which the largest values from among Z1a, Z1b and Z1c values (that is, the maximum Z1a, Z1b and Z1c values) are taken, and the smallest values from among Z2a, Z2b, and Z2c values (that is, the minimum Z2a, Z2b, and Z2c values) are taken. The value indicating the size of the space is then calculated as the minimum dimensions (Z2a, Z2b, Z2c) minus the maximum dimensions (Z1a, Z1b, Z1c) minus D (Minimum (Z2a, Z2b, Z2c)-Maximum (Z1a, Z1b, Z1c)-D). This value is applied as representing the smallest space into which the substrate 3 may be inserted.

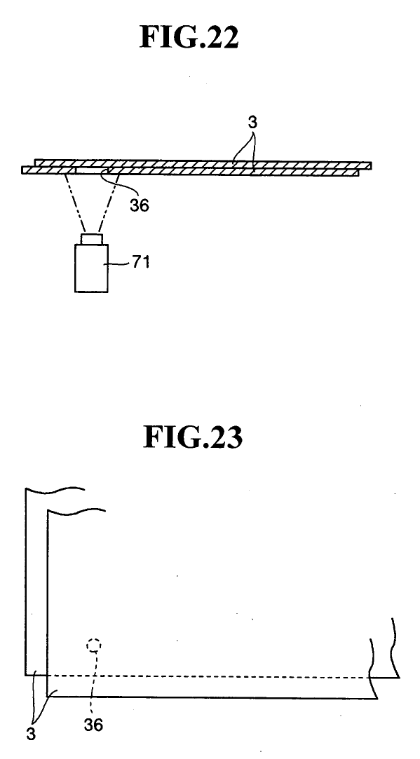

In ‘Step S2’, when the size of the insertion space has been calculated, a determination is made as to whether or not the robot arm will be able to insert the substrate 3. A ‘YES’ determination results in the control sequence continuing to ‘Step S3’, while a ‘NO’ determination results in the control sequence jumping to ‘Step S7’. In ‘Step S3’, as illustrated in FIGS. 22 and 23, the robot arm moves the substrate 3 to a specific position above the fixed position of the camera 71 which monitors the ventilation port 36 before insertion of the substrate 3, and the center of the ventilation port 36 is measured at the stop position, in case of bringing the substrate 3 over the support fixture 34 and terminating by a predetermined robot arm operation.

In ‘Step S4’, with the camera on the robot arm continuing to monitor the center of the evacuation tube 5, a determination is made as to whether or not the center of the evacuation tube 5 is in alignment with the center of the ventilation port 36 measured in ‘Step S3’. A ‘YES’ determination results in the control sequence continuing to ‘Step S5’, while a ‘NO’ determination results in the control sequence jumping to ‘Step S9’. In ‘Step S5’, as it has been determined that the center of the evacuation tube 5 and the ventilation port 36 are in alignment, the robot arm carries the substrate 3 between the support beams 33, and after aligning it over the evacuation tube 5, places it on the support fixture 34 to conclude the substrate loading operation.

After the substrates 3 have been loaded, a ‘Step S6’ will be executed, if necessary, in which the robot arm attaches a clip 35 to secure the substrates 3 to the evacuation tube 5. ‘Step S7’ indicates a condition in which the substrates 3 cannot be inserted between the support beams 33; in other words, a condition in which the support beams 33 have probably become distorted, resulting in the activation of an alarm to alert the condition, and then the control sequence proceeds to ‘Step S8’ where the loading operation of the substrates 3 onto the cart 2 is cancelled. In ‘Step S9’, as the center of the ventilation port 36 has strayed from its specified preset position, a deviation from the specified position has occurred, so a deviation calculation is conducted.

The control sequence then proceeds to ‘Step S10’ where the robot arm stop position is corrected based on the calculation conducted in ‘Step S9’. The control sequence then returns to ‘Step S5’ where the substrates 3 are loaded onto the support fixture 34. This operation places the substrates 3 on the evacuation tube 5, and then ends a loading of the substrates 3 onto the cart 2. This operation is then repeated for each support beam 33.

In this operation in which the substrate loading robot 13 loads the substrates 3 onto the cart 2, the height of the substrate insertion space ‘S’ is measured, and a determination is made as to whether or not the insertion space ‘S’ is sufficient for the insertion of the substrates 3. If the space is sufficient, in order that the ventilation port 36 aligns with the evacuation tube 5, the stop position of the robot arm may be corrected based on data indicating the center of the ventilation port 36 in the substrate 3, and data indicating the center of the evacuation tube 5 in the evacuation tube connector 6. Following this, in order that the substrates 3 are carried over the support fixture 34, the substrate loading robot 13 inserts the substrates 3 into the substrate insertion space ‘S’ through a path which avoids contact with the peripheral components, thus making it possible to load the substrates 3 in the correct position while increasing production efficiency through automatic control of the operation.

The following will describe a mechanism which automates the panel manufacturing operation by responding to thermally induced misalignment, which results from the heat treating operation, of the position of the substrates 3 in relation to the substrate magazine 4. Multiple support fixtures 34 are installed to the substrate magazine 4, each support fixture 34 being capable of supporting at least one pair of substrates 3 loaded thereon. To each support fixture 34 is installed at least one inner support piece 34a adjacent to the evacuation tube 5, and an outer support piece 34b installed at a further distance from the evacuation tube 5, the outer support piece 34b providing easier movement of the pair of substrates 3 supported thereon compared to that of the inner support piece 34a. The outer support piece 34b may be structured as a rocking or swinging-type member. The outer support piece 34b may also be structured as a roller mechanism having its rotational center T passing through the center of the evacuation tube 5 and supporting the pair substrates 3 thereon.

Each component of the cart 2 and the substrates 3 is subject to thermal expansion and contraction as a result of the heat treating process. It must be taken into consideration that the expansion rates of the cart 2 components and substrates 3 are not always uniform, and that the differences between their thermally induced dimensional fluctuations may lead to external force being applied to the joint between the evacuation tube 5 and substrate 3 as well as to the evacuation tube 5 itself. This will induce misalignment between the evacuation tube 5 and the ventilation port 36 on the substrate 3 and breakage of the evacuation tube 5.

As a result of this potential problem, a separate flexible tube is applied as the pipe 46 installed to the cart 2, through which the evacuation tube connector 6 (in which the evacuation tube 5 is mounted) is supported by the projecting member 38, thus forming a flexible mounting structure which does not restrict the movement of the evacuation tube connector 6. While this structure reduces, to a certain extent, the loads or external forces which can be inadvertently applied to the evacuation tube 5 through the evacuation tube connector 6, it should be kept in mind that it may be an obstacle to the automatic control operations, cannot completely eliminate problems caused by the aforesaid misalignment and breakage and may significantly reduce the yield of an automated plasma display panel manufacturing process.

It would be considered that it makes the thermal expansion rate uniform between the substrates 3 and the support beam 33 having the support fixtures 34 or a base plate having the same thermal expansion rate as the substrates 3 is mounted on the support fixtures 34 arranged to the support beam 33. However, the substrates 3 are made of glass, in case of constructing the support beam 33 or base plate also out of glass, the other problems, such as these components being prone to breakage, the increased overall weight of the cart 2, and a reduction in thermal efficiency would still have to be resolved.

As illustrated in FIGS. 24 and 25, on the cart 2, inner support pieces 34a are attached to extending part 74 of the projecting member 38 (which is supported by connecter pillar 37) adjacent to the evacuation tube 5, and outer support pieces 34b are attached to the support beam 33 (which is supported by the support post 32) at locations further separated from the evacuation tube 5 than the inner support pieces 34a. The frictional coefficient between the upper surfaces of the inner support pieces 34a and the substrate 3 is greater than that between the upper surfaces of the outer support pieces 34b and the substrate 3. For example, the inner support pieces 34a may be made from a woven metal, a steel net, or ceramic material to provide a roughly textured top surface, and the outer support pieces 34b may be made from a metal or ceramic with their top surfaces polished to a mirror-like finish. The drawings show a structure in which two inner support pieces 34a are attached to each projecting member 38 in nearly equivalent proximity to the evacuation tube 5.

The substrate 3 rests on the top of the evacuation tube 5, to which a frit seal 21 has been attached, and also on the upward facing surfaces of the support pieces 34a and 34b in an orientation in which the center of the evacuation tube 5 is in alignment with the center of the ventilation port 36 of the substrate 3. As the components constructing the cart 2 and the substrate 3 themselves thermally expand and contract at different rates, a phenomenon which induces variations in their dimensions, the substrate 3 resting on the upper surfaces of the inner support pieces 34a must be supported in a way which isolates them from any movement which could be induced by surrounding components. The outer support pieces 34b support the substrate 3 at their upper surfaces through a mechanism which allows the substrate 3 to slide along the horizontal plane thereon in relation to the surrounding components in order to prevent the connection part between the evacuation tube 5 and substrate 3, and the evacuation tube 5 itself, from being affected by externally generated movements, thus preventing misalignment between the evacuation tube 5 and the ventilation port 36 of the substrate 3 and damage to the evacuation tube 5. The upper portion of each outer support piece 34b may be formed to a partial spherical cross section or as a rotating roller which allows the substrates 3 to slide while being supported thereon.

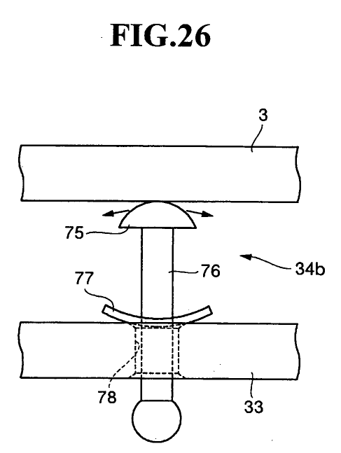

FIG. 26 describes an example of a differently structured outer support piece 34b. In this structure, the outer support piece 34b incorporates a curved or partially spherical upper surface of a head part 75 and a curved or partially spherical lower surface formed of a pivot flange 77 pierced by a center shaft 76 which extends from the head part 75 through a thru-hole 78 opened in the support beam 33 so as to allow the pivot flange 77 to swing freely against the perimeter of the upper portion of the thru-hole 78. The center shaft 76 is able to swing around the intersecting point of the pivot flange 77 at the center of the thru-hole 78. In other words, the outer support piece 34b is designed to allow the substrate 3 to move freely along the horizontal plane in response to forces which induce a changing positional relationship between the substrate 3 and the outer support piece 34b. Moreover, the curved lower surface of the pivot flange 77 enables the top of the head part 75 to remain at a uniform height regardless of the swing angle of the center shaft 76.

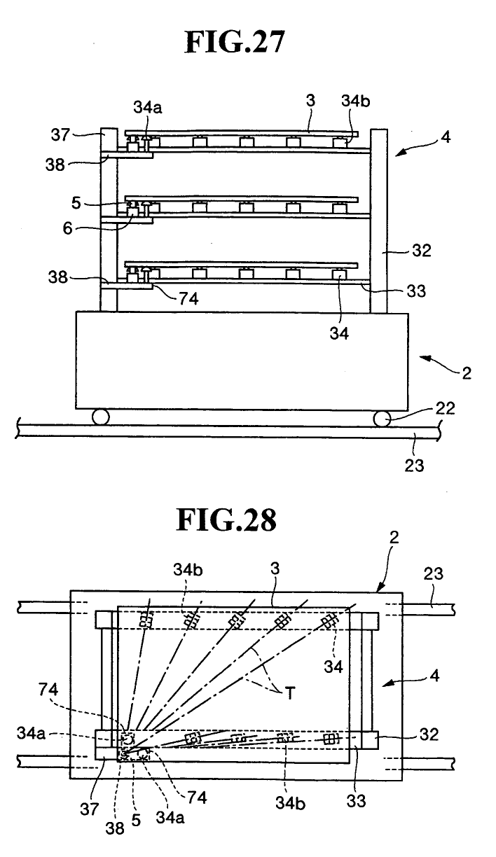

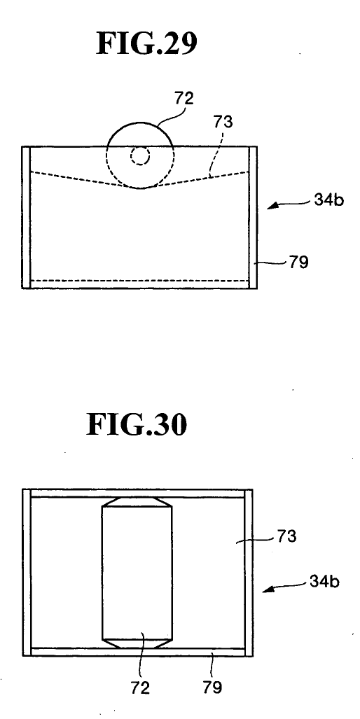

FIGS. 27 through 30 describe another type of support structure in the form of a roller mechanism. In this structure, outer support piece 34b is formed as an open-top box 79 in which a cylindrical roller 72 is placed in a freely rotatable condition. The roller 72 in the box 79 rests on a support surface 73 formed of two inclined planar surfaces extending from a center trough in which the roller 72 resides when not affected by an external force. As the sides of the box 79 extend upward from the two upwardly inclined planar surfaces forming the support surface 73, a structure is formed which prevents the escape of the roller 72 from the box 79.

The outer support piece 34b is arranged that the rotational center T (shown as a chain line in the drawing) of the roller 72 directs toward the evacuation tube 5. Concerning the aforesaid thermal expansion and contraction, the outer support pieces 34b allow the substrate 3 to more easily slide along the horizontal plane than the inner support pieces 34a in relation to the surrounding components in order to prevent the connection part between the evacuation tube 5 and substrate 3, and the evacuation tube 5 itself, from being affected by externally generated movements, thus preventing misalignment between the evacuation tube 5 and the ventilation port 36 of the substrate 3 and damage to the evacuation tube 5.

Although this structure describes two inner support pieces 34a, their number is not limited and may be specified as the structure requires. Also, the evacuation tube 5 is not limited to an upwardly facing orientation, but may also be disposed in a downward facing orientation.

The following will describe the mechanism for easily introducing the automated operation, by which the evacuation tube 5 is sealed and separated from substrate 3 after exiting the heat treating oven 8. The control system, including the robot controller 19 for controlling the evacuation tube sealing-cutting off robot 14, automates the procedure with the aid of an open and closable clamshell-type heater which closes around the evacuation tube 5 as part of the sealing and separating operations.

The operation through which the evacuation tube 5 is sealed and separated from its connection to the substrate 3 is executed after the atmosphere between the two substrates 3 has been evacuated. As the operation through which the evacuation tube 5 is sealed and separated has been conventionally executed manually using a gas burner to melt the appropriate point on the evacuation tube 5, the need to automate this process is evident.

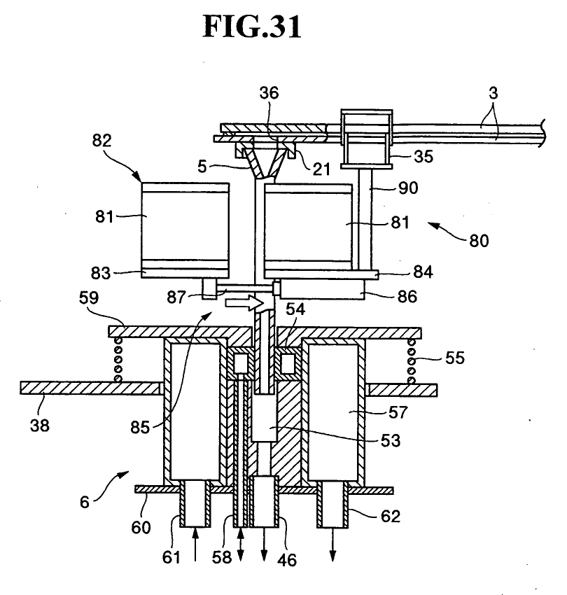

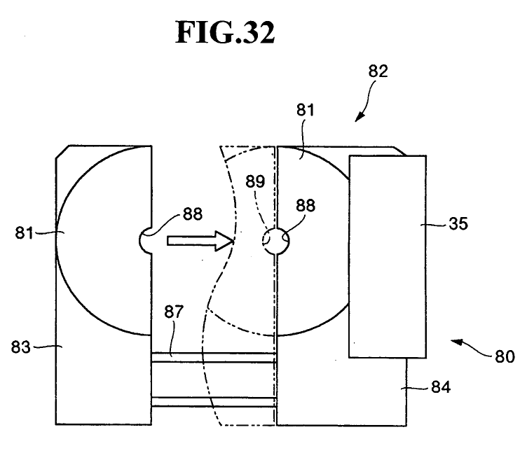

As illustrated in FIGS. 31 and 32, an evacuation tube sealing/separating unit 80 is provided. The sealing/separating unit 80 comprises an insulated casing 82 formed from a pair of casing parts 81, and a heating element (not shown in the drawings) installed within each casing part 81, the heating element having the purpose of applying heat to the external portions of the evacuation tube. The casing 82 are arranged with one casing part 81 installed on a support seat 83, and the other installed on a separate support seat 84. A power cylinder 85 is installed between the support seats 83 and 84, and may be attached, for example, with the cylinder body 86 connected to the support seat 84 and the piston rod 87 connected to the support seat 83, thus forming a structure through which the extension and retraction of the power cylinder 85 is able to open and close the casing 82 in the form of moving one casing part 81 relative to other casing part 81.

Each of the two casing parts 81 is structured as a hollow half cylinder filled with an insulating material, having a semicircular channel 88 formed at the center. When the two casing parts 81 are brought together, that is, closed against each other, the semicircular channels 88 form an enclosed cylindrical space. A heating element is installed along the channels 88. With the casing 82 in a closed condition and the two casing parts 81 in mutual contact, the semicircular channels 88 form a thru-hole 89 which functions as an evacuation tube chamber. A shaft 90 is attached to the support seat 84, and the clip 35 is attached to the top of the shaft 90 to secure the substrates 3.

The electrical discharge gas sealing process is complete after the atmosphere between the substrates 3 has been evacuated. As illustrated in the drawings, the evacuation tube sealing-cutting off robot 14 positions the casing parts 81 on opposite sides of the evacuation tube 5, and then attaches the evacuation tube sealing/separating unit 80 to the substrates 3 by the grip of the clip 35. The attachment of the clip 35 is executed by movement of the robot arm through the use of image data relating to the position of the substrates 3 as monitored by the camera on the robot arm. The retracting movement of the power cylinder 85 brings the casing parts 81 into mutual contact to form a single structure. To be more specific, the evacuation tube 5 resides in the thru-hole 89 and is surrounded by the heater, when the casing 82 is in this closed condition. The heater is then actuated to heat the space around the evacuation tube 5 for a specific period of time. The sealing operation is executed when the region around the evacuation tube 5 comes to a uniform melting temperature. The continued application of electrical power to the heater will result in the subsequent separation of the sealed part.

This structure makes it possible to automate the sealing and separating operations applied to the evacuation tube 5, increases the efficiency of the operation, and by using the evacuation tube sealing-cutting off robot 14 for detachably attaching and removing the evacuation tube sealing/separating unit 80 to and from the substrate 3 with the clip 35, eliminates the preparation of the units 80 for every substrates 3, thus reducing the number of components required.

The automated operation through which the evacuation tube 5 is sealed and separated may also be conducted using a burner instead of a heater. The control system, including the robot controller 19 for controlling the evacuation tube sealing-cutting off robot 14, incorporates a sealing and cutting-off function which is proceeded by using a burner for melting the evacuation tube 5 and an elevator device for lowering the evacuation tube connector 6 as means of stretching the evacuation tube 5, in order to perform the sealing and separating operation to the evacuation tube 5. In other words, the burner may be attached to the robot arm of the evacuation tube sealing-cutting off robot 14 which operates to attach the aforesaid clip 35 to the substrates 3. For example, the elevator device may be installed to lower the evacuation tube connector 6 and thus change its position in relation to the projecting member 38 along the vertical plane. Automated burner position control may be conducted using a method similar to the previously described automated operation in which image data is used to control the insertion of the substrates 3 into the insertion space ‘S’, or the insertion of the evacuation tube 5 into the attachment orifice 53.

In the same manner, image data obtained from a camera is used to control the operation through which the evacuation tube sealing-cutting off robot 14 grips the part of the evacuation tube 5 remaining in the evacuation tube connector 6 after the sealing and separating operation. The high pressure air is removed from the ring-shaped seal 54 in the evacuation tube connector 6 through the air supply/evacuation pipe 58 in order to release the grip of the seal 54 on the remaining part of the evacuation tube 5, and then the remaining part of the evacuation tube 5 may be removed and discarded. The remaining part of the evacuation tube 5 may be removed by the same evacuation tube handling robot 12 which delivered the evacuation tube 5 to the cart 2. If this is done, the air line leading from the evacuation tube connector 6 to the evacuation pump 39 should, as much as possible, be prevented from opening to the atmosphere.

Automatic control is then applied to the operation through which the finished panel is removed from the cart 2, the panel having been previously sealed and separated from the evacuation tube 5. In order to automatically remove the panel from the substrate magazine 4 on the cart 2 and place it on the panel discharge conveyor 16, the control system, which controls operation of the panel unloading robot 15 through the robot controller 19, applies an unloading setting function through which the cart 2 virtual stop position image data and virtual panel loading position image data are obtained and used in the output of control data which controls the operation through which the panel unloading robot 15 unloads the panels. This automatic control function operates in the same manner as that applied to the loading of the substrates 3.

In the operation through which the panels are removed from the cart 2, traversal of the cart 2 stops at a point in front of the panel unloading robot 15 after which the variation between the cart 2 reference stop position and virtual stop position is calculated based on the reference markers 1X, 1Y, and 1Z monitored by the camera. The calculated variation is used for modifying the first measured point which becomes the first reference stop point for the robot arm. Therefore, even though the cart 2 may have stopped at the virtual stop position different from the reference stop position, the robot arm's first measured point can be corrected to the position where the camera can monitor the reference marker 1H on the projecting member 38.

In Step 2, the robot arm stops at the corrected first measurement point, the camera monitors the reference marker 1H on the projecting member 38, and the extent of variation between the panel's reference loading position and virtual loading position is calculated. The second measured point, which is the second reference stop point for the robot arm, is then corrected based on the aforesaid calculated variation. The correct stop point for the robot arm in relation to the panel's virtual loading position is thus determined in Steps 1 and 2.

Applying this type of automatic control mechanism to the operation of the panel unloading robot 15 makes it possible to bring the robot arm to the correct panel unloading position and to appropriately unload the panels from the cart 2 even in cases where the cart 2 has not stopped at its proper stop position, falloffs in manufacturing tolerances have altered dimensions, or components have been subjected to thermal distortion.

1-20. (canceled)

21. A plasma display panel manufacturing system comprising:
a loop-shaped process line;
multiple carts that traverse said process line in a repeatedly starting and stopping sequence;
a substrate magazine associated with each cart, said substrate magazine sized and shaped to accept at least a set of one pair of substrates;
an evacuation tube connector associated with each cart, said evacuation tube connector accommodating a removable attachment of an evacuation tube disposed in opposition to either one of said pair of substrates;
an evacuation unit associated with each cart and connected with said evacuation tube connector, wherein operation of said evacuation unit provides an evacuation process through said evacuation tube;
a heat treating oven installed in said process line that applies a heat treating process to at least a set of said one pair of substrates on said cart during traversal therein to form connections between said pair of substrates and between said evacuation tube and said substrates, and within which an evacuation process is performed wherein gas residing between said pair of substrates is evacuated by said evacuation unit on said cart;
a loading-unloading station adjacent said heat treating oven along the traversing direction of said cart;
a delivery system at said loading-unloading station that delivers stacked pairs of substrates and said evacuation tube;
a robot at said loading-unloading station and controlled by control data such that said robot delivers said evacuation tube and said pair substrates to said evacuation tube connector and substrate magazine on a cart selected to enter said heat treating oven, seals/cuts off the connection between said substrates and evacuation tube on said cart which has exited said heat treating oven, disposes of the remaining evacuation tube after cutting off from said substrates, and unloads finished panels which have been separated from said evacuation tube;
a removal system which removes said finished panels from said loading-unloading station; and
a control system which controls operation of said carts, evacuation unit, heat treating oven, delivery system, robot, and removal system.

22. The plasma display panel manufacturing system according to claim 21, wherein an electrical discharge gas supply unit supplies an electrical discharge gas to the space between pairs of substrates, through said evacuation tube in said evacuation tube connector, during manufacture of the plasma display panel at a point in time after the evacuation process has completed and before the sealing and cutting off operation initiates.

23. The plasma display panel manufacturing system according to claim 21, wherein said evacuation unit comprises an evacuation pump, an open and closable evacuation valve, and an evacuation valve controller, said evacuation valve controller operating to close said evacuation valve when the pressure in the space between said pair substrates has been monitored as having attained a specified pressure.

24. The plasma display panel manufacturing system according to claim 21, wherein said electrical discharge gas supply unit is equipped with an electrical discharge gas supply source, an open and closable supply valve through which an electrical discharge gas from said electrical discharge gas supply source is fed to said evacuation tube, and a gas supply valve controller which closes said supply valve when the gas pressure in the space between said pair substrates is monitored as having attained a specified pressure.

25. The plasma display panel manufacturing system according to claim 21, wherein a drive mechanism initiates, maintains, and terminates traversal of said cart, and a locking device detachably connects to the stopped cart to secure said cart to said process line following termination of traversal.

26. The plasma display panel manufacturing system according to claim 21, wherein said control system actuates operation of said robot to attach said evacuation tube to said evacuation tube connector and then place at least said one pair of substrates into said substrate magazine to substantially simultaneously complete placement of one substrate against said evacuation tube and the loading operation of said pair substrates to said substrate magazine.

27. The plasma display panel manufacturing system according to claim 21, wherein said control system incorporates a supply action setting function which, to provide automatic execution of an operation in which said evacuation tube is taken from said delivery system to said evacuation tube connector on said cart, obtains positional image data indicating the cart's virtual stop position and the evacuation tube's virtual attachment position, and outputs control data, based on the positional image data, to actuate said robot which executes the evacuation tube delivery operation.

28. The plasma display panel manufacturing system according to claim 27, wherein said supply action setting function:
obtains image data of virtual stop position based on preset data indicating a cart reference stop position,
corrects a cart stop position from a deviation between the virtual stop position and the reference stop position,
obtains image data of a virtual installation position based on preset data indicating the reference installation position for said evacuation tube connector from the cart stop position,
corrects the evacuation tube connector installation position from a deviation between the virtual installation position and the reference installation position,
obtains virtual attachment position image data for said evacuation tube,
corrects the evacuation tube attachment position from the deviation between the virtual attachment position and the preset reference attachment position for said evacuation tube, and
outputs a corrected evacuation tube supply action, in the form of control data, to said robot which executes the supply action.

29. The plasma display panel manufacturing system according to claim 21, wherein said control system incorporates an evacuation tube removal correction function which
obtains virtual standby status image data for said evacuation tube at the removal standby position,
corrects the removal operation based on a variation of virtual standby status data from preset standby status reference data for said evacuation tube, and
outputs the corrected removal operation as control data.

30. The plasma display panel manufacturing system according to claim 21, wherein said control system incorporates an evacuation tube attachment correction function which
obtains image data relating to virtual status of a grip of said robot on said evacuation tube,
corrects the attachment operation based on a deviation of virtual grip status data from preset grip status reference data, and
outputs a corrected attachment operation as control data.

31. The plasma display panel manufacturing system according to claim 21, wherein said evacuation tube connector is structured to include an attachment orifice to which said evacuation unit is connected and into which said evacuation tube is removably inserted in a vertical orientation, and a ring seal installed within said attachment orifice, said ring seal being structured to form the air-tight sealing in the periphery of said evacuation tube by applying pressure against or releasing pressure from around said evacuation tube.

32. The plasma display panel manufacturing system according to claim 31, wherein a vertically sliding structure facilitates sliding movement of said evacuation tube connector in upward and downward directions, regardless of any deformation of said ring seal to place a top of said evacuation tube in pressurized contact with one substrate of said pair of substrates, and a pressurizing device is provided to apply pressure against said evacuation tube connector, in an upward direction.

33. The plasma display panel manufacturing system according to claim 21, wherein said substrate magazine has multiple segmenting members defining substrate insertion spaces into which at least a set of said one pair substrates is inserted, and said control system incorporates a loading determination function which, to provide automatic execution of operation through which said pair of substrates is inserted into said substrate insertion space, obtains dimensions of said substrate insertion space as image data, and outputs control data, based on the image data, which indicates if said pair of substrates can or cannot not be inserted into said substrate insertion space.

34. The plasma display panel manufacturing system according to claim 21, wherein said control system includes a loading correction function which, to provide automatic execution of operation through which said robot places said evacuation tube residing in said evacuation tube connector in said cart against a ventilation port of at least a set of one pair of substrates supplied from said delivery system by said robot,
obtains image data indicating the center of said evacuation tube in an attached condition to said evacuation tube connector and indicating the center of said ventilation port at the loading standby position for said pair of substrates,
applies the center position image data to calculate the variation to the center positions of said evacuation tube and said ventilation port according to a reference loading operation previously set to said robot for supplying said pair substrates to said substrate magazine from the loading standby position, and
outputs the corrected loading operation as control data based on the variation.

35. The plasma display panel manufacturing system according to claim 21, wherein said substrate magazine includes multiple support members at multiple locations, each support member being capable of supporting said pair substrates through at least one inner support piece proximal to said evacuation tube and through outer support pieces further separated there from, said outer support pieces supporting said pair substrates more slidable than said inner support piece, thereby allowing less restricted movement of said pair substrates placed thereon.

36. The plasma display panel manufacturing system according to claim 35, wherein said outer support piece moves with a swinging pendulum-like action.

37. The plasma display panel manufacturing system according to claim 35, wherein said outer support piece is structured in the form of a roller mechanism having a rotating axis passing through an axial center of said evacuation tube.

38. The plasma display panel manufacturing system according to claim 21, wherein said control system automatically controls operation of an open and closable clamshell-type heater constructed of two parts able to close around said evacuation tube to seal and cut off said evacuation tube.

39. The plasma display panel manufacturing system according to claim 21, wherein said control system automatically controls a burner for melting said evacuation tube and an elevator device for lowering said evacuation tube connector as means of stretching said evacuation tube to perform a sealing and separating operation to said evacuation tube.

40. The plasma display panel manufacturing system according to claim 21, wherein said control system includes an unloading setting function which, to provide automatic unloading of said finished panels from said substrate magazine on said cart and their placement in said removal system,
obtains image data indicating a virtual stop position of said cart and a virtual panel loading position, and
outputs control data, based on the image data, to said robot to execute a panel unloading operation.
